(19) United States
(12) Patent Application Publication
(10) Pub. No.: US 2002/0002482 A1
(43) Pub. Date: Jan. 3, 2002

(54) METHOD AND APPARATUS FOR PERFORMING SURVEYS ELECTRONICALLY OVER A NETWORK

(76) Inventor: C. DOUGLAS THOMAS, CAMPBELL, CA (US)

Correspondence Address: C DOUGLAS THOMAS, 1193 CAPRI DRIVE, CAMPBELL, CA, 95008

(21) Appl. No.: 08/886,349

(22) Filed: Jul. 1, 1997

Related U.S. Application Data
(60) Provisional application No. 60/021,114, filed on Jul. 3, 1996.

(51) Int. Cl. G06F 17/60

(52) U.S. Cl. 705/10; 434/362

(57) ABSTRACT

An automated survey system that performs surveys over electronic media is described. The system receives a survey in an electronic format, the survey having survey questions. Then, a group of registered survey participants is selected for participation in the survey. Next, the survey is electronically distributed to the registered survey participants in the group selected. Responses to the survey questions are then electronically received from the registered survey participants in the group selected. The survey system then processes the responses to determine survey results. The automated survey system is advantageous because it provides a more effective, less cumbersome way to carry out a survey. Survey participants are more willing to participate and surveys can be completed significantly faster than conventionally possible. The surveys can also incorporate multimedia effects for much broader, more realistic and entertaining surveys.

This application claims the benefit of U.S. Provisional Application Ser. No. 60/021,114 filed on Jul. 3, 1996, the disclosure of which is incorporated herein by reference.

### BACKGROUND OF THE INVENTION

1. Field of the Invention

The present invention relates to surveys and, more particularly, to more efficient and effective survey systems, methods and businesses.

2. Description of the Related Art

The need for surveys arises due to various reasons. Some of the major reasons for surveys are market research, elections, public opinions, and legal. The surveys associated with these major reasons are known as market research surveys, electoral polls, public opinion polls, and legal surveys.

Conventionally, surveys are carried out by telephone or by mail. With telephone surveys a group of people are telephoned to elicit responses of a series of survey questions which are asked by a telephone operator and answered by the persons called. With a mail survey, prospective survey participants are mailed a survey form having questions thereon. The prospective participant is then asked to complete the survey form and mail back the form to the survey organization.

The conventional approach to carrying out a survey is as follows. First, survey questions are prepared depending on the needs for the particular survey and then printed. Next, a group of individuals to take the survey, known as participants, are identified. The participants are usually selected from a mailing list or phone list. In most cases, the participants are randomly selected. However, sometimes the participants are able to be restricted to persons of a particular geographical region. For example, for a California public opinion poll, the participants attempt to restrict the survey to California residents. Usually, the individuals would be identified by name and address, but address alone is often times all that is available. A more general survey, such as a nationwide market research survey, would include persons from many different geographical areas of the country. After having identified the participants for the survey, the survey would be presented to the participants. Most often, the survey is presented by either a mailer to the participants' home or work address or a telephone call to the participants' home or work phone number.

There are numerous problems with conventional survey approaches. One major problem with the conventional approach is that carrying out a survey is cumbersome in many ways. The mailing or phoning is cumbersome because it is labor intensive and for that reason expensive. The mailings required are also slow to complete because it requires that the survey itself be mailed, completed, and then returned. The collating and tabulating of the responses to the survey is also cumbersome and labor intensive. Another major problem with the conventional approach of carrying out a survey is that the participants (i.e., recipients of the survey) are often times not willing participants, particularly with mailers and phone initiated surveys. As a result, only a small percentage of the surveys tends to ever be completed and returned. Still another problem of conventional surveys is that the survey participants cannot be limited to specific biographic or demographic classes of participants. At best, conventional approaches could categorize responding participants based on responses to questions in the survey that provide demographic information.

Thus, there is a need to carry out surveys in a more effective, less cumbersome way whereby survey participants are willing to participate and the survey process is less cumbersome to implement.

### SUMMARY OF THE INVENTION

The invention pertains to an automated survey technique that performs surveys over electronic media. The automated survey technique according to the invention provides a more effective, less cumbersome way to carry out a survey. Survey participants are more willing to participate and surveys can be completed significantly faster than conventionally possible. The surveys can also incorporate multimedia effects for much broader, more realistic and entertaining surveys.

The invention can be implemented in numerous ways, including as a method, an apparatus, or a system, or on a computer readable media.

As a computer implemented method for performing a survey, an embodiment of the invention includes the operations of: receiving a survey in an electronic format, the survey having survey questions; selecting a group of registered survey participants for participation in the survey; electronically distributing the survey to the registered survey participants in the group selected; electronically receiving responses to the survey questions from the registered survey participants in the group selected; and processing the responses to determine survey results. Optionally, the embodiment also electronically distributes the survey results to a survey requester.

As a method for operating a survey business, an embodiment of the invention includes the operation of: receiving a survey request form a survey requester; producing a survey in an electronic format based on the survey request; selecting a group of participants from a plurality of previously registered survey participants; electronically distributing the survey in the electronic format to the group of participants; electronically receiving responses to the survey from the group of participants; generating an electronic survey report from the responses; and electronically transmitting the electronic survey report to the survey requester.

As a survey system coupled to a network, an embodiment of the invention includes: an active survey/response database for storing an active survey having survey questions and for storing responses to the survey questions by particular survey participants; a participants database for storing classification information on a plurality of participants; a survey manager for selecting a group of participants from the participants database, electronically distributing the active survey to the group of participants over the network, receiving responses to the survey questions of the survey over the network, and producing a survey report from the responses; and a network interface for coupling the survey manager to the network.

As a computer readable media containing computer instructions for performing a survey, an embodiment of the invention includes: computer code devices for receiving a survey in an electronic format, the survey having survey questions; computer code devices for selecting a group of registered survey participants for participation in the survey; computer code devices for electronically distributing the survey to the registered survey participants in the group selected; computer code devices for electronically receiving responses to the survey questions from the registered survey participants in the group selected; and computer code devices for processing the responses to determine survey results.

Advantages of the invention are numerous. First, the participants are willing to participate in surveys because they have previously registered for doing so. Second, electronic surveys can be targeted to specific categories of participants with minimal effort. Third, the speed (or turn-around time) for surveys is substantially improved because they are implemented electronically and with automation. Fourth, the expense involved in executing surveys is reduced significantly. Fifth, the surveys are also able to incorporate multimedia aspects for much broader, more realistic and entertaining surveys.

Other aspects and advantages of the invention will become apparent from the following detailed description, taken in conjunction with the accompanying drawings, illustrating by way of example the principals of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a network arrangement according to an embodiment of the invention;

FIG. 2 is a block diagram of a survey system according to an embodiment of the invention;

FIG. 3 is a block diagram of an embodiment of a survey manager according to an embodiment of the invention;

FIG. 4 is a flow diagram of survey processing according to an embodiment of the invention;

FIG. 5 is a flow diagram of a survey generation processing according to an embodiment of the invention;

FIG. 6 is a flow diagram of survey distribution processing according to an embodiment of the invention;

FIG. 7 is a flow diagram of another embodiment of survey distribution processing; and

FIG. 8 is a flow diagram of registration processing according to an embodiment of the invention.

### DETAILED DESCRIPTION OF THE INVENTION

The invention pertains to an automated survey technique that performs surveys over electronic media. The automated survey technique according to the invention provides a more effective, less cumbersome way to carry out a survey. Survey participants are more willing to participate and surveys can be completed significantly faster than conventionally possible. The surveys can also incorporate multimedia effects for much broader, more realistic and entertaining surveys.

The survey is in an electronic form and may include items other than textual survey questions. In particular, the survey could include graphical images, video clips, audio sound bites, or some combination thereof Suitable existing data compression techniques can help reduce the amount of data associated with the survey having these more data intensive characteristics. For example, in a marketing survey, a graphical image of a proposed product could be included in the survey for the participants viewing. Likewise, the survey could have audio and video clips embedded therein to obtain the participants feedback.

Potential survey participants register electronically via a computer if they desire to participate in surveys. To motivate computer users to become registered participants, incentives can be provided. Suitable incentives can vary widely. For example, the incentives might include sweepstakes offer, free services, money (credit card debit, savings deposit, money market deposit), coupons, frequent flier miles, and the like. Once a participant has registered, a file is maintained on the participant in a database. The file includes various information concerning the participant that is useful for selecting participants for surveys as well as categorizing the participant when producing survey results.

When a survey requester places a request for a survey, the survey is generated. Then, based on participant categories identified for the survey, participants are selected for the survey. The survey is then electronically transmitted to the selected survey participants. The selected survey participants then complete the survey and have their responses electronically returned. Survey results are then determines from the responses of the participants. From the survey results, a survey report may be created and transmitted to the survey requester.

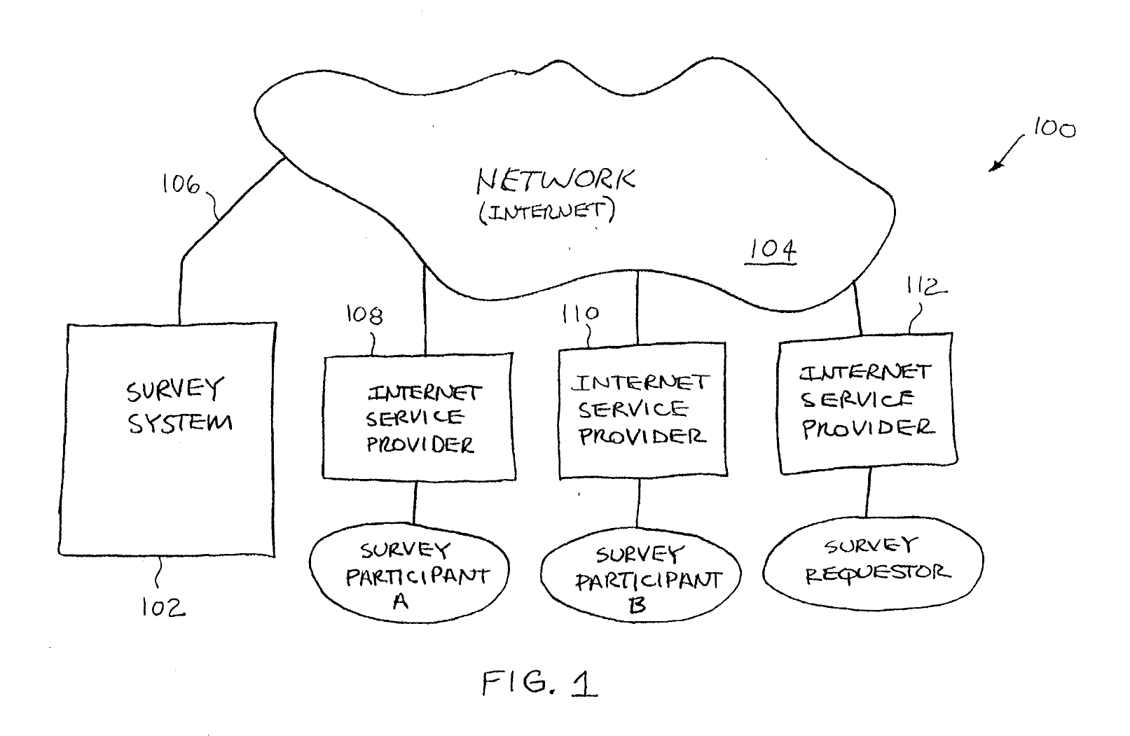

Embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a network arrangement 100 according to an embodiment of the invention. The network arrangement 100 includes a survey system 102 that is coupled to a network 104 via a communication link 106. The survey system 102 performs surveys over the network 104. The survey system 102 carries out the surveys electronically with only willing participants so that the survey process is substantially more efficient and less cumbersome to implement than conventionally possible. The network 104 can be a variety of types and sizes, including one or a combination of a Local Area Network (LAN), a Wide Area Network (WAN), and the Internet.

The network arrangement 100 illustrated in FIG. 1 is particularly designed for an implementation of the invention in which the network 104 is the Internet. The survey system 102 forwards a survey to participants and receives responses from the participants over the Internet 104. For example, in the case of two participants as illustrated in FIG. 1, survey participant A is coupled to the Internet 104 through an Internet service provider 108 and survey participant B is coupled to the Internet 104 through an Internet service provider 110. The Internet service providers 108 and 110 are usually connected to the Internet 104 using high performance links such as ISDN or T1 lines. The survey participants A and B would using computers connect to the Internet 104 through the Internet service providers 108 and 110, respectively.

The network arrangement 100 also includes a survey requester. The survey requester is the person or organization requesting a survey. In the particular implementation illustrated in FIG. 1, from a computer, the survey requester is able to couple to the Internet 104 through an Internet service provider 112. Then, from the Internet 104, the survey requester is able to electronically send a survey request to the survey system 102.

The computers utilized by the survey participants A and B and the survey requester would respectively couple to the Internet service providers 108, 110, 112 via modems and telephone lines. Higher performance links, such as ISDN or T1 lines, could also be used to connect the computers to the Internet service providers 108, 110 and 112. In other embodiments, the computers can couple to the network 104 more directly through network interface cards and dedicated wires, modems and phone lines, or even through wireless means. The computers utilized by the survey participants A and B and the survey requester can have many sizes and shapes.

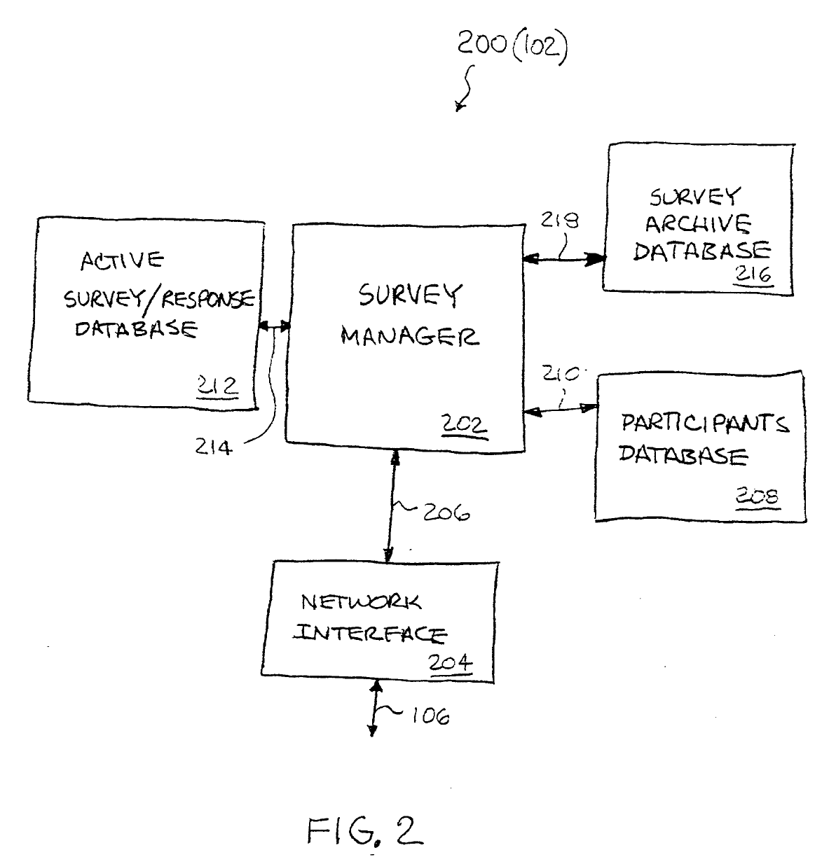

FIG. 2 is a block diagram of a survey system 200 according to an embodiment of the invention. The survey system 200 is an embodiment of the survey system 102 illustrated in FIG. 1.

The survey system 200 includes a survey manager 202 that manages and controls all the survey related operations. The survey manager 202 is coupled to a network interface 204 via a communication link 206. The network interface 204 is coupled to the network 104 via the communication link 106. The network interface 204 interfaces the survey manager 202 to the network 104. The survey manager 202 is also coupled to a participants database 208 via a communication link 210. The participants database 208 stores information about potential survey participants. The information stored in the participants database 208 includes, for example, demographic and biographic information concerning a plurality of participants. The survey system 200 also includes an active survey/response database 212 for storing an active survey as well as responses to the active survey that have been received by the survey system 200. The active survey/response database 212 is coupled to the survey manager 202 via a communication link 214. In addition, the survey system 200 includes a survey archive database 216 that is coupled to the survey manager 202 via a communication link 218. The survey archive database 216 stores those surveys and their corresponding responses after they are no longer active, meaning that no more responses are considered. The survey and its responses are thus archived for possible future use.

The survey manager 202 carries out the survey (survey processing). Although the survey processing is now briefly described, it is described in detail below. The survey manager 202 selects the participants for a particular survey, and then electronically transmits the a survey questions to each of the selected participants. The survey questions may be transmitted as an executable file that executes locally on a computer, or may by a displayed page (HTML page) transmitted by a server via a network connection. In the case of the executable file (perhaps in conjunction with a local machine resident program) present each of the survey questions to the participants and obtain responses thereto. After all the questions have been answered, the executable file produces a response data file that is to be transmitted back to the survey manager 202. The survey manager 202 then processes the survey responses to produce survey results from the survey responses. The survey results may include predicted conclusions. The survey results are then forwarded to the survey requester as a printed report, an electronic message, or an electronic file.

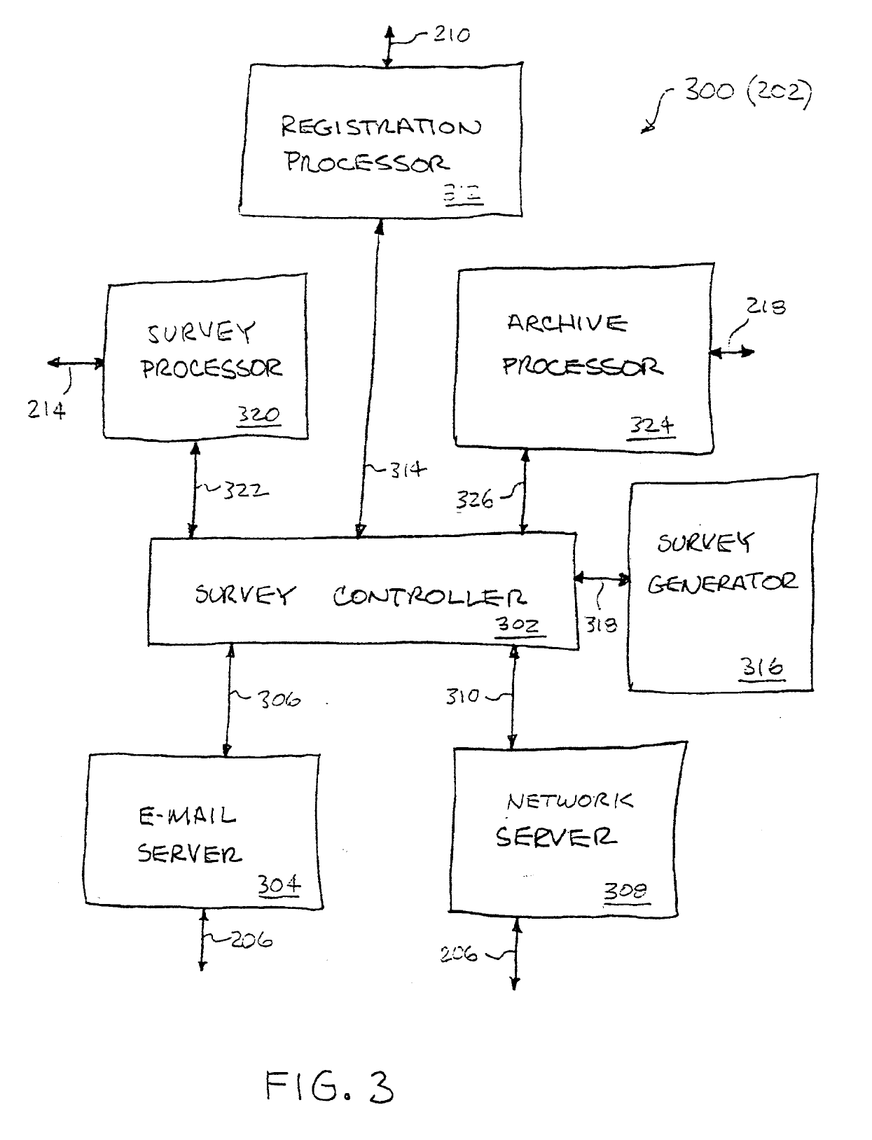

FIG. 3 is a block diagram of an embodiment of a survey manager 300 according to an embodiment of the invention. The survey manager 300 represents a detailed embodiment of the survey manager 202 illustrated in FIG. 2.

The survey manager 300 includes a survey controller 302 that controls the operations of the survey manager 202. The survey controller 302 is coupled to an e-mail server 304 through a communication link 306. The e-mail server 304 interfaces to the network 104 through the communication link 206 so as to send and receive survey related e-mail over the network. The survey controller 302 is also connected to a network server 308 through a communication link 310. The network server 308 is connected to the network 104 through the communication link 206 so as to provide survey related data and services over the network 104. In the case in which the network 104 is the Internet, the network server 308 is referred to as a World Wide Web server.

Although the embodiment of the survey manager 300 illustrated in FIG. 3 includes both the e-mail server 304 and the network server 308, other embodiments may also combine these servers into a single server or provide only one type of server. Also, it should be noted that the e-mail server 304 and the network server 308 need not be part of the survey manager 202; instead, such server(s) need only be made available to the survey system 102 and interface with the network 104.

The survey manager 300 also includes a registration processor 312 that is coupled to the server controller 302 through a communication link 314. The registration processor 312 operates to perform a registration process. In particular, the registration processor 312 obtains a registration information pertaining participants and interacts with the participants database 208 through the communication link 210 to store the registration information.

A survey generator 316 is also coupled to the survey controller 302 through a communication link 318. The survey generator 316 may or may not be part of the survey manager 300. That is, the survey generator 316 could be a separate apparatus or process from the survey manager 202, 300. When the survey generator 316 is part of the survey system 300, the survey generator 316 operates to generate the active survey in an electronic format. When the survey generator 316 is separate process or process, the survey in the electronic format is generated elsewhere and then received by the survey system 300.

The survey controller 302 is also connected to a survey processor 320 through a communication link 322. The survey processor 320 operates to carry out or perform the survey generated by the survey generator 316. In so doing, the survey processor 320 interacts through the communication link 214 with the active survey/response database 212 which stores the active survey and related responses.

In addition, the survey controller 302 is further coupled to an archive processor 324 through a communication link 326. The archive processor 324 is coupled to the survey archive database 216 through the communication link 218. The archive processor 324 stores the active survey and its responses to the survey archive database 216 when the survey becomes inactive.

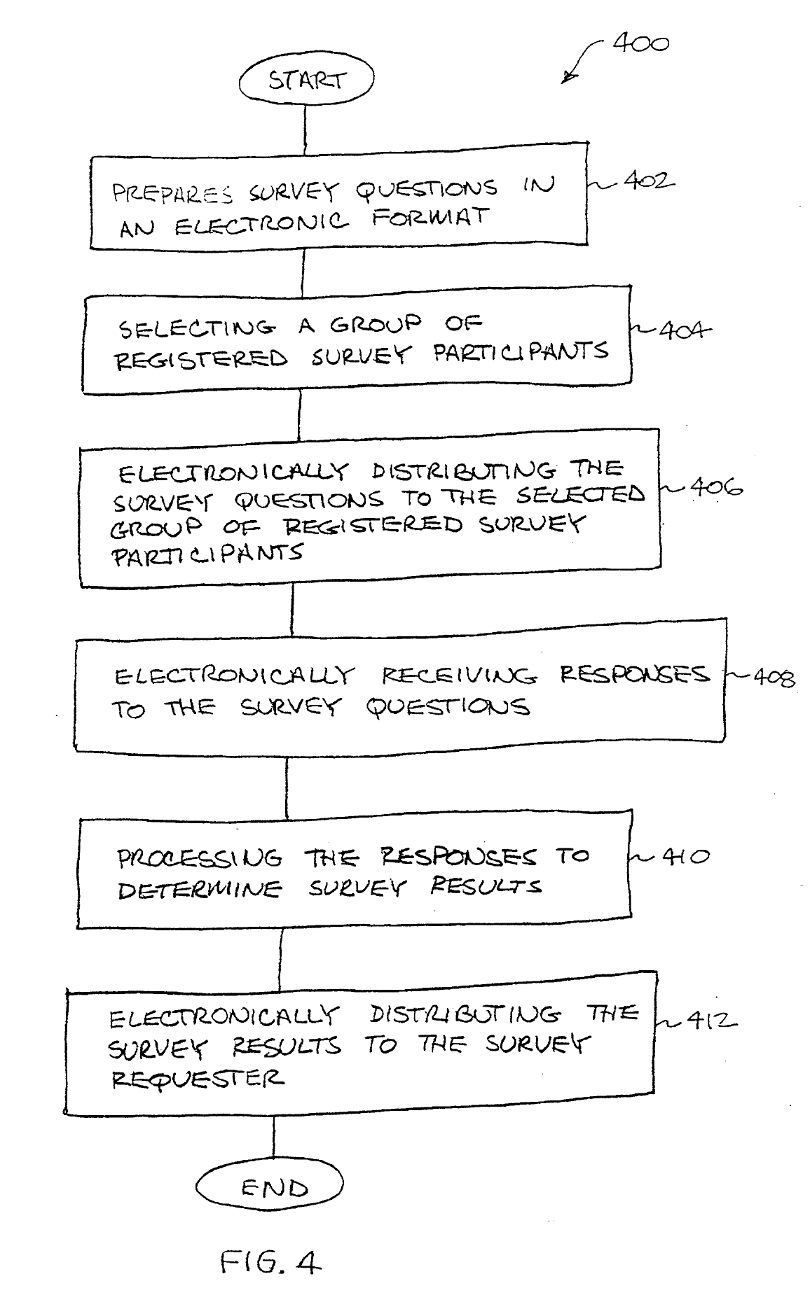

FIG. 4 is a flow diagram of survey processing 400 according to an embodiment of the invention. The survey processing 400 is a computer implemented process. In one embodiment, the survey processing 400 is carried out by the survey system 102.

A survey processing 400 initially prepares 402 survey questions in an electronic format. That is, the survey questions are either received or generated and then placed in an electronic format that facilitates electronic distribution of the survey. Next, a group of registered survey participants is selected 404. For example, the group of registered survey participants can be selected 404 from the participants that have been previously registered and have their registration information stored in the participants database 208. Typically, the survey will be limited or directed to specific categories of participants. Hence, the group of registered survey participants that are selected 404 should be limited to those participants that are within the requested categories.

Thereafter, the survey questions are electronically distributed 406 to the selected group of registered survey participants. The electronic distribution is performed over a network so that the survey questions can be rapidly supplied to the selected group of registered survey participants. For example, the survey questions can be electronically distributed 406 to the selected group of registered survey participants through electronic mail, file transfer or down load via the network. For example, the electronic distribution 406 can be achieved by attaching executable survey code to an e-mail message that is send to each of the selected group of registered survey participants, or by notifying each of the selected group of registered survey participants by e-mail that they have been selected to participate in a survey and that they are to gain access to the survey page on via the World Wide Web page associated with the survey system 102.

Once the participants in the selected group of registered survey participants that have received the survey questions of the survey (via the electronic distribution), they are able to perform the survey and provide responses to the survey questions.

Preferably, the survey questions of the survey are contained within executable code that is what is distributed to the selected group of registered survey participants. Hence, the participants need only execute the executable code and provide response when prompted to take or complete the survey.

Thereafter, as the participants complete the survey, the responses to the survey questions are electronically received 408 at the survey system. That is, the selected group of registered survey participants, after having completed the survey, returns their responses and it is these responses that are electronically received 408. Preferably, the responses are received by the survey system 102 by either an e-mail message (e.g., a reply e-mail message replying to the original e-mail that sent the notification message and possible the executable survey code) or from the survey page via the World Wide Web associated with the survey system 102. With a participant completing the survey on-line, i.e., while connected the World Wide Web, the responses are retrieved as soon as the participant completes the survey. When the participant completes the survey off-line, the responses could be returned to the survey system 102 the next time the participant is on-line.

Next, the survey processing 400 processes 410 the responses to determine survey results. The processing of the responses to produce the survey results typically includes some kind of tabulation or summarization of the responses to the survey questions given the participant categories or classifications to which the survey questions were directed. However, the survey results can include more detailed analysis of the responses by using the information not only in the responses but also information known about the participants contained in the participants database 208 as well as perhaps information in the survey archive database 216.

Finally, the survey results are electronically distributed 412 to the survey requester. Here, the survey results are rapidly forwarded to the survey requester so that the survey requester has the desired information that was originally requested in an efficient and effective manner. In one embodiment, a survey report on the survey results is e-mailed to the survey requester. In another embodiment, a data file (e.g., a database table file) including the survey results is e-mailed to the survey requester, and then the survey requester can produce a customized survey report or otherwise make use of the data.

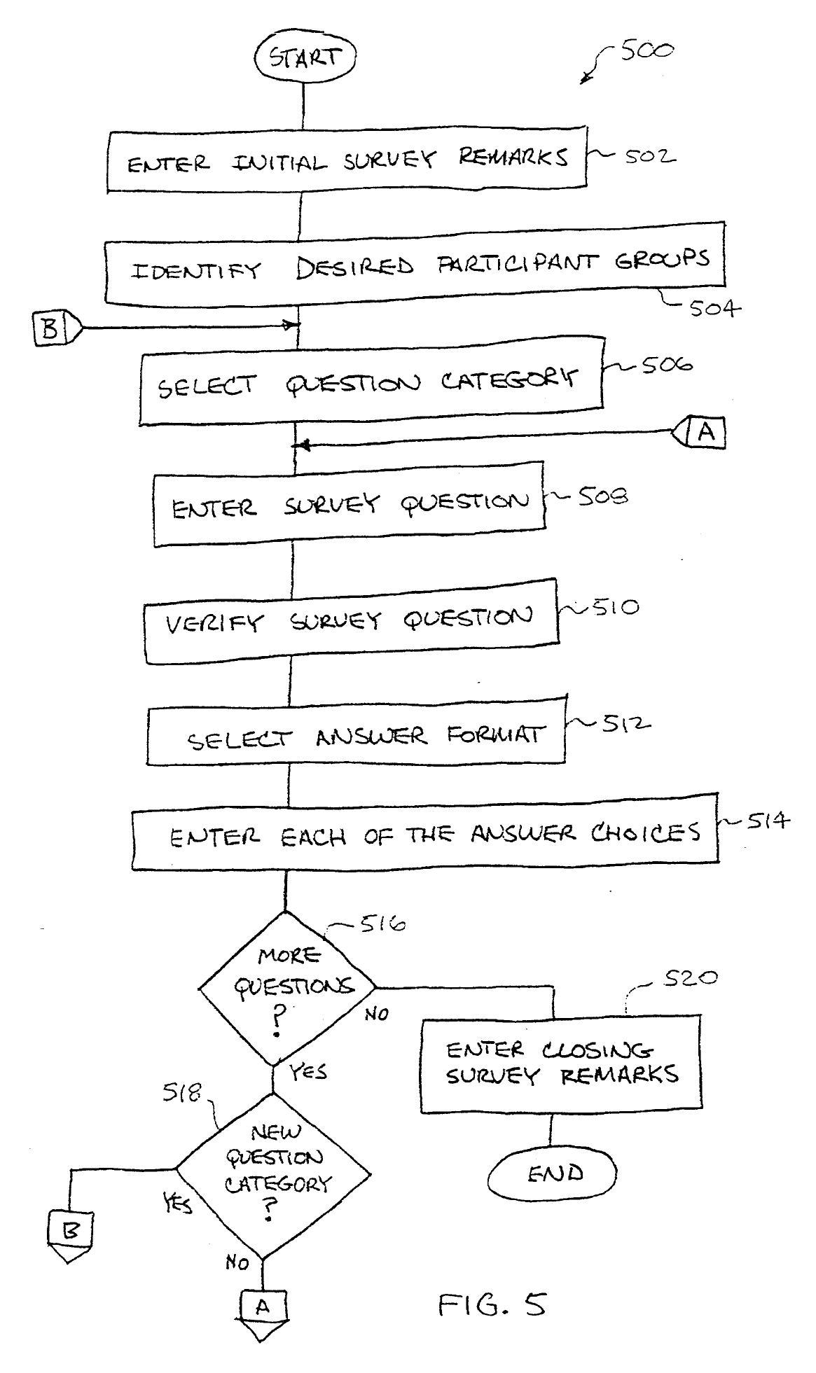

FIG. 5 is a flow diagram of a survey generation processing 500 according to an embodiment of the invention. The survey generation processing 500 can, for example, be performed by the survey generator 316. However, the survey generation processing 500 can also be performed independent of the survey system 102.

The survey generation processing 500 is an automated techniques to produce an electronic survey. Preferably, the survey generation processing 500 is a computer-implemented process carried out by the survey requester on a computer, in this way the survey requester is able to visually see and create the survey to be distributed as well as lessening the demands on the survey system 102.

Initially, the survey requester enters 502 initial survey remarks. The initial survey remarks are the remarks that the survey requester desires to place at the beginning or introductory portion of the survey to inform the participants that take the survey some background or other information. Next, the survey requester identifies 504 desired participant groups or categories. These desired participant groups or categories typically correspond to groups or categories maintained in the participant database 208. For examples, the survey requester could be presented with a displayed list of available participant groups or categories, and then the survey requester would select those desired. Examples of participants groups or categories include age, gender, address, race, political affiliation, salary range, job, and many more.

Next, the survey requester selects 506 a question category. The question category is the basic type of questions that the survey requester wishes to next ask in the survey. For example, question categories may include biographic information, heritage information, lifestyle information, product marketing, public opinion, demographic, etc. In one embodiment, the question categories are presented to the survey requester in the form of a displayed list

Then, the survey requester enters 508 a survey question. Here, the survey requester types in the question on the computer, chooses from a database of questions, or imports questions from another program (e.g., wordprocessor). The survey question is then verified 510. The verification, for example, checks the length, spelling and format of the question.

The survey requester then selects 512 an answer format for the survey question. The answer format can take a variety of forms and depends on the type of question being asked. For example, the answer formats may include true or false; good, better or best; multiple choices, and the like. Next, the survey requester enters 514 each of the answer choices for the survey question in accordance with the answer format that has been selected. The number of answer choices, if any, that the survey requester needs to enter 514 varies with the answer format. For example, for the true or false format, no answer choices would be entered, but for multiple choice, multiple answer choices would be entered.

A decision 516 then determines whether there are any more questions that the survey requester wishes to-include in the survey. If there are additional survey questions to be asked, then a decision 518 determines whether the next survey question relates to a new question category. If the next survey question does not relate to a new question category, the survey generation processing repeats block 508 and subsequent blocks to enter information pertaining to the next survey question. On the other hand, if the next survey question does require a new question category, the survey generation processing 500 returns to repeat block 506 and subsequent blocks. In any event, when the decision block 516 determines that there are no more questions to be asked in the survey, then the survey requester enters 520 closing survey remarks. The closing survey remarks are those remarks that the survey requester wishes to provide to the participants at the end of the survey. Following block 520, the survey generation processing 500 is complete and ends. At this point, the electronic survey has been prepared.

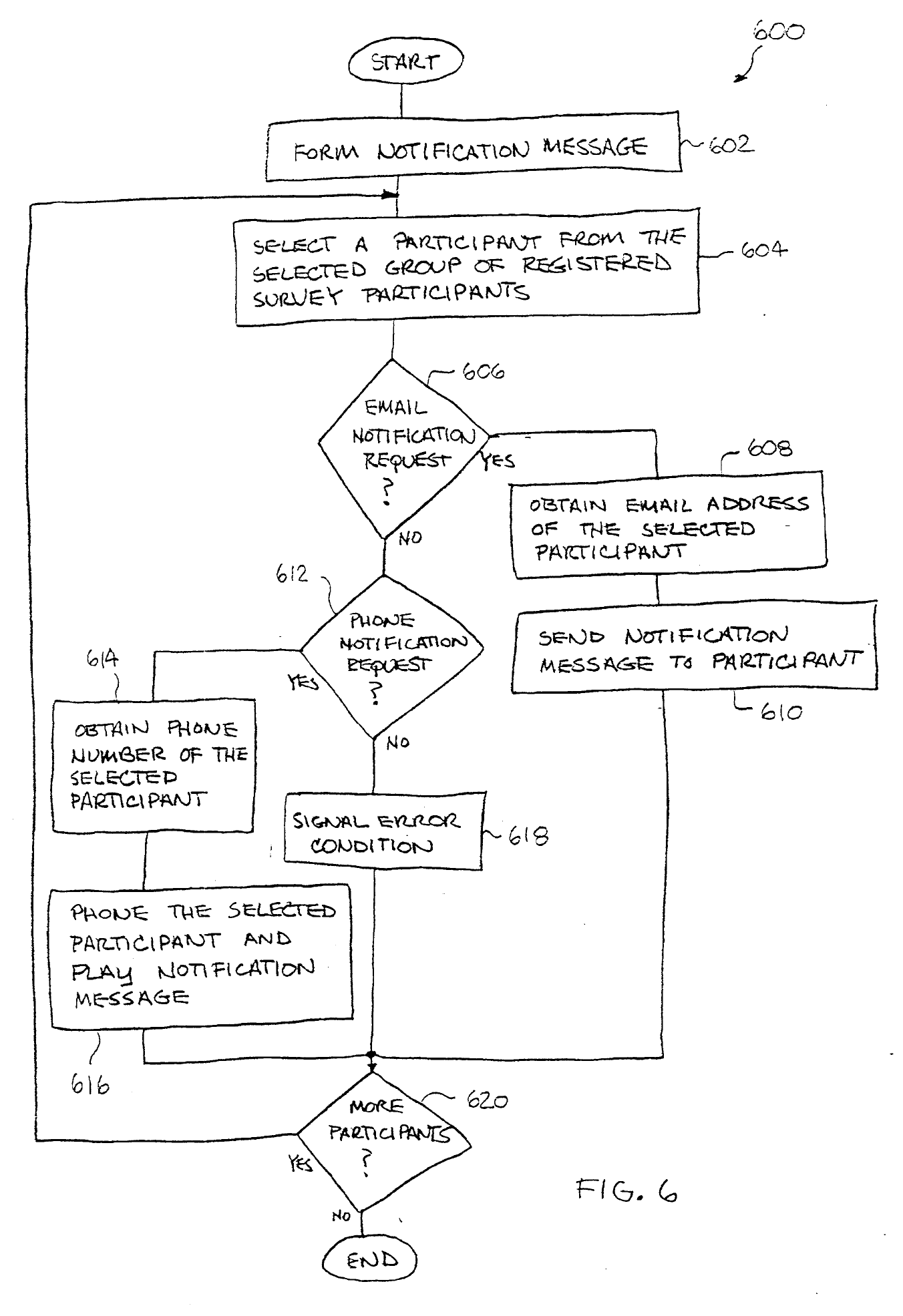

FIG. 6 is a flow diagram of survey distribution processing 600 according to an embodiment of the invention. In one embodiment, the survey distribution processing 600 is performed by the survey manager 202 of the survey system 102.

The survey distribution processing 600 initially forms 602 a notification message. The notification message serves as a message that will notify participants that there is a survey for them to complete. Next, a participant is selected 604 from the selected group of registered survey participants. Then, a decision 606 determines whether the selected participant has requested e-mail notification for available surveys. The decision block 606, for example, can check information within the participants database 208 associated with the selected participant to determine whether, during the registration process, the selected participant requested e-mail notification. If the decision block 606 determines that e-mail notification has been requested, the e-mail address of the selected participant is obtained 608. The e-mail address of the selected participant can be obtained 608 from the participant database 208. Next, the notification message is sent 610 to the participant. Here, the notification message is sent as an electronic mail message to the e-mail address of the participant.

On the other hand, when the decision block 606 determines that the selected participant has not requested e-mail notification, a decision 612 determines whether the selected participant has requested phone notification. If the selected participant has requested phone notification, a phone number for the selected participant is obtained 614. The phone number of the selected participant can be obtained 614 from the participant database 208. Following block 614, the selected participant is phoned 616 and the notification message is played. Preferably, a computerized audio dialing and announcement system is used to play the notification message, alternatively, a human operator can perform this operation. In the case in which neither e-mail notification or phone notification are requested, an error condition exists, and the notification processing 600 signals 618 the error condition.

Following blocks 610, 616 or 618, a decision 620 determines whether there are additional participants that need to be notified. If the decision block 620 determines that there are additional participants that need to be notified, the notification processing 600 returns to repeat block 604 and subsequent blocks. On the other hand, when all the participants have been notified, the notification processing 600 is complete and ends.

With the notification processing 600 illustrated in FIG. 6, the participants that have been selected to take the survey are notified that a survey exists for them to take. However, in this embodiment, the notification message invites or instructs the participants to access a survey page via the World Wide Web or other network to obtain the survey. For example, a selected participant, after being notified, would receive a survey name, a survey password and/or an identifier and would then use a computer to connect to the survey system 102 to obtain access to the survey. As an example, the selected participants could access the survey page (survey web page) using the network 104 (Internet) and the network server 308 (Web server). Once at the survey page, the survey can be completed on-line or downloaded and then responses returned by either logging back on to the survey page or through e-mail.

It should be noted that although FIG. 6 illustrates both e-mail and phone notification, only one form of notification is needed, preferably that is e-mail.

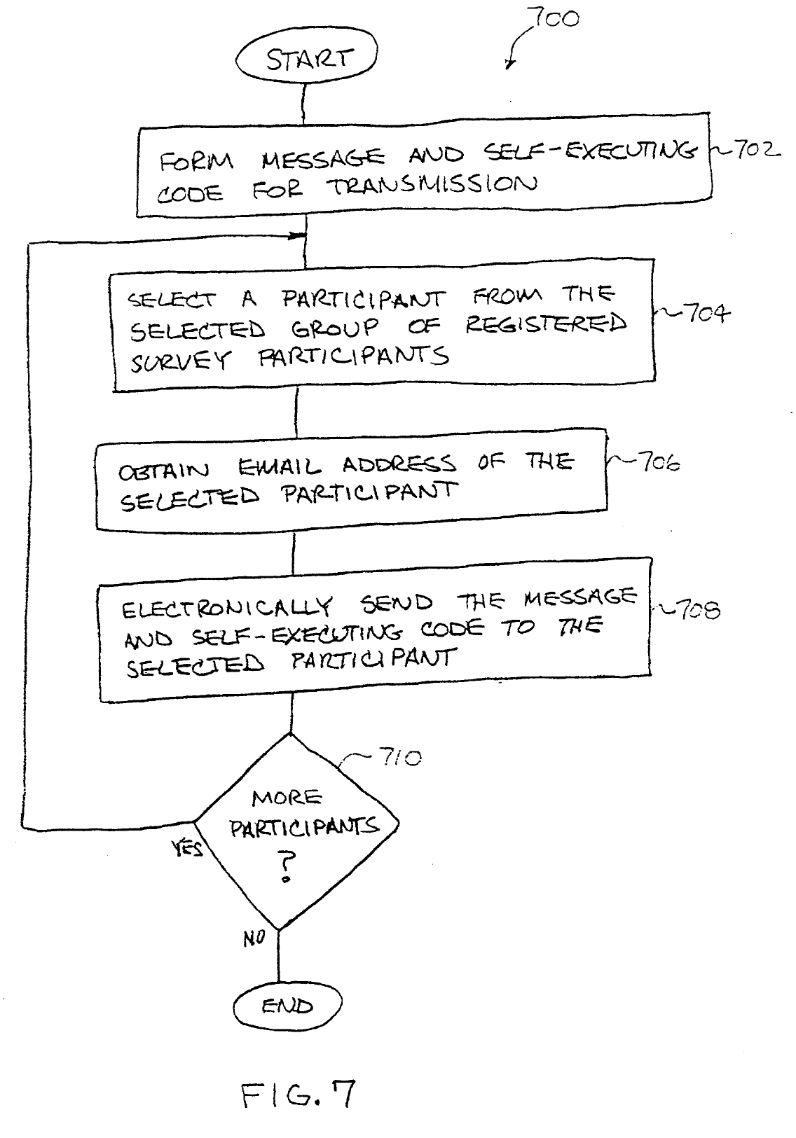

FIG. 7 is a flow diagram of another embodiment of survey distribution processing 700. The survey distribution processing 700 of this embodiment provides not only a notification message but also the survey to the participants.

Initially, the survey distribution processing 700 forms 702 both a message and self-executing code for transmission. Here, the message is essentially a notification message that attached hereto is a survey that the participant is encouraged to complete. The survey is preferable attached to the notification message as a file containing self-executing code.

Next, a participant is selected 704 from the selected group of registered survey participants. Then, the e-mail address for the selected participant is obtained 706. In one embodiment, the e-mail address of the selected participant can be obtained from the participant database 208.

Then, the message and self-executing code are electronically sent 708 to the selected participant. In one embodiment, the message is the text of an e-mail message and the file containing the self-executing code is an attachment to the notification mail message. When executing the file on computer (such as the computer on which the participant received the e-mailed notification message), the survey and a graphical user interface are presented to the participant and lead the participant through completing the survey.

Next, a decision 710 determines whether there are additional participants that need to receive the survey. If there are additional participants to which the survey needs to be distributed, the survey distribution processing 700 returns to repeat block 704 and subsequent blocks. Once all the participants have received the survey, the survey distribution processing 700 is complete and ends.

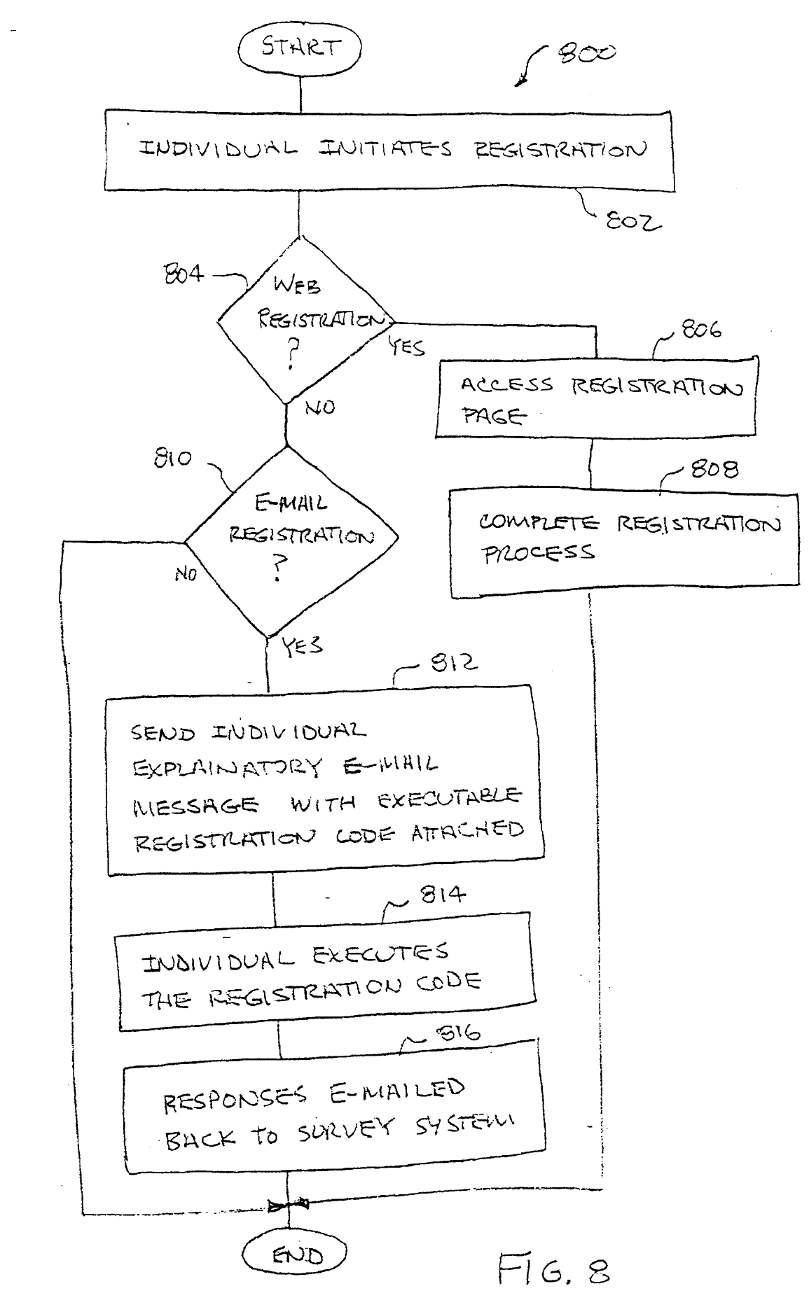

FIG. 8 is a flow diagram of registration processing 800 according to an embodiment of the invention. The registration processing 800 operates to obtain information about individuals that register. The information obtained through registration can vary but would preferably include biographical data about themselves and their economic, marital, and social characteristics. In one embodiment, the registration processing 800 is performed by the survey manager 202, more particularly, the registration processor 312.

The registration processing 800 begins once an individual initiates 802 registration. Preferably, advertising, incentives and referrals motivate individuals to seek to register to participate in surveys. The incentives may include one or more of money, sweepstakes, drawing, services, etc. After an individual has initiated 802 the registration processing 800, a decision determines whether the individual is attempting to register by connecting to the network server 308 over the network 104. Namely, this would be the situation in which the individual registers over the Internet via a registration page. When the decision block 804 determines that registration is attempted by connecting to the network server 308 over the network 104, then the individual accesses 806 the registration page. Then, while accessing the registration page, the individual completes 808 the registration process. In completing the registration process, the individual completes a registration form. Usually, in this case, the registration can be completed on-line (that is, while connected). Alternatively, the individual could down-load a executable code that would allowed completion of the registration form and then the individual would reconnect to return the completed registration form to the survey manager 202. The registration form could also be returned by e-mail.

On the other hand, when the decision block 804 determines that registration not being attempted by connecting to the network server 308 over the network 104, a decision 810 determines whether registration is being attempted by e-mail. Registration by e-mail is performed by the individual sending a request to the survey system 102 for a registration form. When the decision block 810 determines that registration is being attempted by e-mail, then the survey system 102 sends 812 the individual an explanatory e-mail message having a file containing executable registration code attached. The individual then executes 814 the file containing the executable registration code. When the file is executed on the individual's computer, the individual is presented with the registration form and is guided in completing the registration form. Thereafter, the responses to the registration form are e-mailed 816 back to the survey system 102. Here, the responses are saved to a response file which is then attached to a reply e-mail message.

Following blocks 808 and 816, the registration processing 800 is complete and ends. Also, in the case in which the decision block 810 determines that e-mail registration is not being requested, then the registration processing 800 also ends because only server connection and e-mail types of electronic registration are available in the embodiment illustrated in FIG. 8.

Advantages of the invention are numerous. First, the participants are willing to participate in surveys because they have previously registered for doing so. Second, electronic surveys can be targeted to specific categories of participants with minimal effort. Third, the speed (or turn-around time) for surveys is substantially improved because they are implemented electronically and with automation. Fourth, the expense involved in executing surveys is reduced significantly. Fifth, the surveys can also incorporate multimedia effects for much broader, more realistic and entertaining surveys.

Additional advantages of the invention are that the responses of survey participants are returned electronically and then processed automatically to not only collate the responses but also archive the survey data. A further advantage is that the invention can also verify integrity of participants responses can be verified against earlier response given with respect to earlier surveys. Yet another advantage is that bibliographic information of a users can be updated automatically from the survey responses.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A computer implemented method for performing a survey, comprising:
(a) receiving a survey in an electronic format, the survey having survey questions;
(b) selecting a group of registered survey participants for participation in the survey;
(c) electronically distributing the survey to the registered survey participants in the group selected;
(d) electronically receiving responses to the survey questions from the registered survey participants in the group selected; and
(e) processing the responses to determine survey results.

2. A computer implemented method as recited in claim 1, wherein the survey is requested by a survey requester, and
wherein said method further comprises:
(f) electronically distributing the survey results to the survey requester.

3. A computer implemented method as recited in claim 1, wherein said electronically distributing (c) comprises:
(c1) forming a survey notification message;
(c2) obtaining electronic mail addresses for the registered survey participants in the group selected; and
(c3) electronically sending the notification message to the registered survey participants at their electronic mail addresses.

4. A computer implemented method as recited in claim 3, wherein attached to the electronic notification message is the survey in an electronic, executable form, and when the survey is invoked by the participant, the participant is guided through the survey, and as the participant answers the survey questions, responses are remembered for subsequent electronic transmission.

5. A computer implemented method as recited in claim 4, wherein the survey is implemented by a survey system, and wherein when the participant completes the survey, the remembered responses are electronically transmitted to the survey system.

6. A computer implemented method as recited in claim 3, wherein the electronic notification message informs the participant to obtain and complete the survey by accessing a predetermined world wide web site.

7. A computer implemented method as recited in claim 6, wherein said electronically distributing (c) further comprises:
(c4) accessing the predetermined world wide web site;
(c5) invoking the survey by an action taken by the participant while accessed to the predetermined world wide web, and
wherein once invoked, the participant is guided through the survey and, as the participant answers the survey questions, responses are remembered for subsequent electronic transmission.

8. A computer implemented method as recited in claim 1, wherein said receiving (a) comprises preparing the survey in the electronic format.

9. A computer implemented method as recited in claim 1, wherein said method further comprises:
(f) registering participants to form a database of registered survey participants, and
wherein said selecting (b) selects the registered survey participants from the database.

10. A method for operating a survey business, said method comprising:
(a) receiving a survey request form a survey requester;
(b) producing a survey in an electronic format based on the survey request;
(c) selecting a group of participants from a plurality of previously registered survey participants;
(d) electronically distributing the survey in the electronic format to the group of participants;
(e) electronically receiving responses to the survey from the group of participants;
(f) generating an electronic survey report from the responses; and
(g) electronically transmitting the electronic survey report to the survey requester.

11. A method as recited in claim 10, wherein the survey request includes a plurality of questions and a number of participant categories, and
wherein said selecting (c) operates to select the group of participants from the plurality of previously registered survey participants in accordance with the participant categories.

12. A method as recited in claim 11, wherein the survey is electronically provided only to a number of those of the previously registered participants that are within the demographic participant categories of the survey request.

13. A method as recited in claim 10, wherein the survey in the electronic format includes a plurality of questions and a plurality of corresponding answer choices.

14. A method as recited in claim 13, wherein at least one of the questions or at least one of the answer choices of the survey in the electronic format has a graphic image associated therewith and which the participants in the group of participants view in completing the survey.

15. A method as recited in claim 13, wherein at least one of the questions or at least one of the answer choices of the survey in the electronic format has an audio segment associated therewith and which the participants in the group of participants hears in completing the survey.

16. A method as recited in claim 13, wherein at least one of the questions or at least one of the answer choices of the survey in the electronic format has a video clip associated therewith and which the participants in the group of participants views in completing the survey.

17. A survey system coupled to a network, comprising:
an active survey/response database for storing an active survey having survey questions and for storing responses to the survey questions by particular survey participants;
a participants database for storing classification information on a plurality of participants;
a survey manager for selecting a group of participants from said participants database, electronically distributing the active survey to the group of participants over the network, receiving responses to the survey questions of the survey over the network, and producing a survey report from the responses; and
a network interface for coupling said survey manager to the network.

18. A survey system as recited in claim 17, wherein said survey system further comprises:
a survey archive database for storing inactive surveys and the responses thereto, and
wherein said survey manager determines when the active survey becomes an inactive survey, and when the active survey becomes an inactive survey, manages the movement of the survey from said active survey/response database to said survey archive database.

19. A survey system as recited in claim 17, wherein said survey manager comprises:
a survey processor for interacting with said active survey/response database;
a registration processor for interacting with said participants database to register participants and store their registration information in said participants database;
a survey generator for generating the active survey in an electronic format;
a survey controller for controlling the operations of said survey processor and said registration processor, said controlling including distributing the active survey or a notification thereof to a group of participants from said participants database and for allowing participants to register and for allowing the group of participants complete the active survey and return responses;
a server for interfacing to the network.
